(19) United States
(12) Patent Application Publication
(10) Pub. No.: US 2026/0333256 A1
(43) Pub. Date: Oct. 22, 2026

(54) METHODS AND APPARATUSES FOR RESOURCE ALLOCATION IN UNLICENSED SPECTRA

(71) Applicant: Lenovo (Beijing) Limited, Beijing (CN)

(72) Inventors: Xin Guo, Beijing (CN); Haipeng Lei, Beijing (CN); Zhennian Sun, Beijing (CN); Xiaodong Yu, Beijing (CN)

(73) Assignee: Lenovo (Beijing) Limited, Beijing (CN)

(21) Appl. No.: 19/127,611

(22) PCT Filed: Nov. 7, 2022
(86) PCT No.: PCT/CN2022/130425

§ 371 Date: May 6, 2025

(51) Int. Cl. H04W 56/00; H04L 5/00

(52) U.S. Cl. CPC H04W 56/0015; H04L 5/0048; H04L 5/0055

(57) ABSTRACT

Embodiments of the present disclosure relate to methods and apparatuses for resource allocation in unlicensed spectra. According to an embodiment of the present disclosure, a user equipment (UE) can include: a transmitter configured to transmit, within a sidelink synchronization signal block (S-SSB) period, information related to S-SSB transmission; a processor coupled to the transmitter and configured to determine whether or not to utilize one or more class-2 S-SSB occasions within the S-SSB period for S-SSB transmission based at least in part on the information related to S-SSB transmission; and a receiver coupled to the processor.

### TECHNICAL FIELD

Embodiments of the present application are related to wireless communication technology, and more particularly, related to methods and apparatuses for resource allocation in unlicensed spectra.

### BACKGROUND

A sidelink (SL) is a long-term evolution (LTE) feature introduced in 3rd generation partnership project (3GPP) Release 12, and enables a direct communication between proximal user equipments (UEs), in which data does not need to go through a base station (BS) or a core network. A sidelink communication system has been introduced into 3GPP 5G wireless communication technology, in which a direct link between two UEs is called a sidelink.

Sidelink synchronization information is carried in a sidelink synchronization signal block (S-SSB). In an unlicensed spectrum, SL transmissions and S-SSB transmissions may be multiplexed in some cases. Therefore, new designs for resource allocation for SL transmissions and S-SSB transmissions in unlicensed spectra are needed.

### SUMMARY OF THE APPLICATION

Embodiments of the present application at least provide a technical solution for resource allocation for SL transmissions and S-SSB transmissions in unlicensed spectra.

According to some embodiments of the present application, a UE may include: a transmitter configured to transmit, within an S-SSB period, information related to S-SSB transmission; a processor coupled to the transmitter and configured to determine whether or not to utilize one or more class-2 S-SSB occasions within the S-SSB period for S-SSB transmission based at least in part on the information related to S-SSB transmission; and a receiver coupled to the processor.

In some embodiments of the present application, the information related to S-SSB transmission is transmitted on a resource configured, pre-configured, or pre-defined for the UE.

In some embodiments of the present application, the information related to S-SSB transmission is a request indicating at least one of: requesting class-2 S-SSB occasion(s) within the S-SSB period for S-SSB transmission; requesting a first number of class-2 S-SSB occasion(s) within the S-SSB period for S-SSB transmission; or requesting a set of class-2 S-SSB occasion(s) within the S-SSB period for S-SSB transmission.

In some embodiments of the present application, the receiver is configured to receive a response indicating allocated class-2 S-SSB occasion(s) to the UE for S-SSB transmission in response to the request, and the processor is configured to determine to utilize the allocated class-2 S-SSB occasion(s) within the S-SSB period for S-SSB transmission.

In some embodiments of the present application, the response indicates at least one of: whether the UE can utilize all class-2 S-SSB occasion(s) within the S-SSB period located after a resource on which the response is carried for S-SSB transmission; whether the UE can utilize class-2 S-SSB occasion(s) requested by the UE for S-SSB transmission; a second number of class-2 S-SSB occasions within the S-SSB period allocated to the UE for S-SSB transmission; or a set of class-2 S-SSB occasions within the S-SSB period allocated to the UE for S-SSB transmission.

In some embodiments of the present application, the response is received via at least one of: downlink control information (DCI), a medium access control (MAC) control element (CE), or a radio resource control (RRC) signaling.

In some embodiments of the present application, in the case that the request indicates requesting class-2 S-SSB occasion(s) for S-SSB transmission, the processor is configured to determine to utilize all class-2 S-SSB occasion(s) within the S-SSB period located after an offset relative to the resource on which the request is carried for S-SSB transmission; in the case that the request indicates requesting the first number of class-2 S-SSB occasion(s), the processor is configured to determine to utilize the first number of class-2 S-SSB occasion(s) within the S-SSB period for S-SSB transmission, wherein a first one of the first number of class-2 S-SSB occasion(s) is located after an offset relative to the resource on which the request is carried; and in the case that the request indicates requesting the set of class-2 S-SSB occasion(s), the processor is configured to determine to utilize the set of class-2 S-SSB occasion(s) for S-SSB transmission.

In some embodiments of the present application, the information related to S-SSB transmission is a first indicator related to a failure of transmission(s) on at least one class-1 S-SSB occasion within the S-SSB period, and the processor is configured to: obtain a linkage which defines a mapping relationship between class-1 S-SSB occasion(s) and class-2 S-SSB occasion(s) within the S-SSB period; and determine to utilize a set of class-2 S-SSB occasion(s) corresponding to the at least one class-1 S-SSB occasion based on the mapping relationship.

In some embodiments of the present application, the linkage is based on at least one of the following granularities: per resource pool or per subcarrier spacing (SCS); and/or the linkage is configured, pre-configured, or pre-defined for the UE.

In some embodiments of the present application, the first indicator indicates at least one of: a failure of transmission(s) on the at least one class-1 S-SSB occasion within the S-SSB period; or an index of a class-1 S-SSB occasion within the S-SSB period on which a failure of transmission occurs.

In some embodiments of the present application, the information related to S-SSB transmission is a second indicator indicating a release of class-2 S-SSB occasion(s).

In some embodiments of the present application, the second indicator is transmitted in response to at least one of the following conditions: the UE has successfully performed S-SSB transmission(s) on class-1 S-SSB occasion(s) within the S-SSB period; the UE has successfully performed S-SSB transmission(s) on first N1 S-SSB occasion(s) within the S-SSB period, wherein 0<N1≤N_{MAX}, and N_{MAX} is a total number of S-SSB occasions included in the S-SSB period; the UE decides not to transmit S-SSB; the UE detects successful S-SSB transmission(s) performed by other UE(s) on class-1 S-SSB occasion(s) within the S-SSB period; or the UE detects successful S-SSB transmission(s) performed by other UE(s) on first N2 S-SSB occasion(s) within the S-SSB period, wherein 0<N2≤N_{MAX}.

In some embodiments of the present application, the second indicator indicates at least one of: a release of class-2 S-SSB occasion(s) that has not been utilized by the UE within the S-SSB period; a release of a third number of class-2 S-SSB occasion(s) within the S-SSB period; or a release of a set of class-2 S-SSB occasion(s) within the S-SSB period.

According to some other embodiments of the present application, a BS may include: a receiver configured to receive, within an S-SSB period, information related to S-SSB transmission from a UE; a processor coupled to the receiver and configured to determine whether or not one or more class-2 S-SSB occasions within the S-SSB period are utilized by the UE for S-SSB transmission based at least in part on the information related to S-SSB transmission; and a transmitter coupled to the processor.

In some embodiments of the present application, the information related to S-SSB transmission is received on a resource configured, pre-configured, or pre-defined for the UE.

In some embodiments of the present application, the information related to S-SSB transmission is a request indicating at least one of: requesting class-2 S-SSB occasion(s) within the S-SSB period for S-SSB transmission; requesting a first number of class-2 S-SSB occasion(s) within the S-SSB period for S-SSB transmission; or requesting a set of class-2 S-SSB occasion(s) within the S-SSB period for S-SSB transmission.

In some embodiments of the present application, the transmitter is configured to transmit a response indicating allocated class-2 S-SSB occasion(s) to the UE for S-SSB transmission in response to the request.

In some embodiments of the present application, the response indicates at least one of: whether the UE can utilize all class-2 S-SSB occasion(s) within the S-SSB period located after a resource on which the response is carried for S-SSB transmission; whether the UE can utilize class-2 S-SSB occasion(s) requested by the UE for S-SSB transmission; a second number of class-2 S-SSB occasion(s) within the S-SSB period allocated to the UE for S-SSB transmission; or a set of class-2 S-SSB occasion(s) within the S-SSB period allocated to the UE for S-SSB transmission.

In some embodiments of the present application, the response is transmitted via at least one of: DCI, a MAC CE, or an RRC signaling.

In some embodiments of the present application, in the case that the request indicates requesting class-2 S-SSB occasion(s) for S-SSB transmission, the processor is configured to determine that all class-2 S-SSB occasion(s) within the S-SSB period located after an offset relative to the resource on which the request is carried are utilized by the UE for S-SSB transmission; in the case that the request indicates requesting the first number of class-2 S-SSB occasion(s), the processor is configured to determine that the first number of class-2 S-SSB occasion(s) within the S-SSB period are utilized by the UE for S-SSB transmission, wherein a first one of the first number of class-2 S-SSB occasion(s) is located after an offset relative to the resource on which the request is carried; and in the case that the request indicates requesting the set of class-2 S-SSB occasion(s), the processor is configured to determine that the set of class-2 S-SSB occasion(s) is utilized by the UE for S-SSB transmission.

In some embodiments of the present application, the information related to S-SSB transmission is a first indicator related to a failure of transmission(s) on at least one class-1 S-SSB occasion within the S-SSB period, and the processor is configured to: determine, based on a linkage defining a mapping relationship between class-1 S-SSB occasion(s) and class-2 S-SSB occasion(s) within the S-SSB period, that a set of class-2 S-SSB occasion(s) corresponding to the at least one class-1 S-SSB occasion is utilized by the UE for S-SSB transmission.

In some embodiments of the present application, the linkage is based on at least one of the following granularities: per resource pool or per subcarrier spacing (SCS); and/or the linkage is configured, pre-configured, or pre-defined for the UE.

In some embodiments of the present application, the first indicator indicates at least one of: a failure of transmission(s) on the at least one class-1 S-SSB occasion within the S-SSB period; or an index of a class-1 S-SSB occasion within the S-SSB period on which a failure of transmission occurs.

In some embodiments of the present application, the information related to S-SSB transmission is a second indicator indicating a release of class-2 S-SSB occasion(s).

In some embodiments of the present application, the second indicator indicates at least one of: a release of class-2 S-SSB occasion(s) that has not been utilized by the UE within the S-SSB period; a release of a third number of class-2 S-SSB occasion(s) within the S-SSB period; or a release of a set of class-2 S-SSB occasion(s) within the S-SSB period.

According to some other embodiments of the present application, a BS may include: a receiver; and a processor coupled to the receiver and configured to: in the case that the receiver receives no request for class-2 S-SSB occasion(s) within an S-SSB period for S-SSB transmission up to a time point within the S-SSB period, determine that all remaining class-2 S-SSB occasion(s) within the S-SSB period can be allocated for sidelink transmission; and a transmitter coupled to the processor.

In some embodiments of the present application, the time point is after first N3 S-SSB occasion(s) within the S-SSB period, wherein 0<N3≤N_{MAX}, and N_{MAX} is a total number of S-SSB occasions included in the S-SSB period.

According to some other embodiments of the present application, a method performed by a UE may include: transmitting, within an S-SSB period, information related to S-SSB transmission; and determining whether or not to utilize one or more class-2 S-SSB occasions within the S-SSB period for S-SSB transmission based at least in part on the information related to S-SSB transmission.

According to some other embodiments of the present application, a method performed by a BS may include: receiving, within an S-SSB period, information related to S-SSB transmission from a UE; and determining whether or not one or more class-2 S-SSB occasions within the S-SSB period are utilized by the UE for S-SSB transmission based at least in part on the information related to S-SSB transmission.

According to some other embodiments of the present application, a method performed by a BS may include: in the case that the BS receives no request for class-2 S-SSB occasion(s) within an S-SSB period for S-SSB transmission up to a time point within the S-SSB period, determining that all remaining class-2 S-SSB occasion(s) within the S-SSB period can be allocated for sidelink transmission.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary S-SSB slot according to some embodiments of the present application;

FIG. 3 illustrates an exemplary distribution of S-SSB occasions in the time domain according to some embodiments of the present application;

FIG. 4 illustrates another exemplary distribution of S-SSB occasions in the time domain according to some other embodiments of the present application;

FIG. 5 illustrates yet another exemplary distribution of S-SSB occasions in the time domain according to some other embodiments of the present application;

FIG. 6 illustrates a flowchart of an exemplary method for resource allocation in an unlicensed spectrum according to some embodiments of the present application;

FIG. 7 illustrates a flowchart of an exemplary method for resource allocation in an unlicensed spectrum according to some other embodiments of the present application; and

FIG. 8 illustrates a simplified block diagram of an exemplary apparatus for resource allocation in an unlicensed spectrum according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G new radio (NR), 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

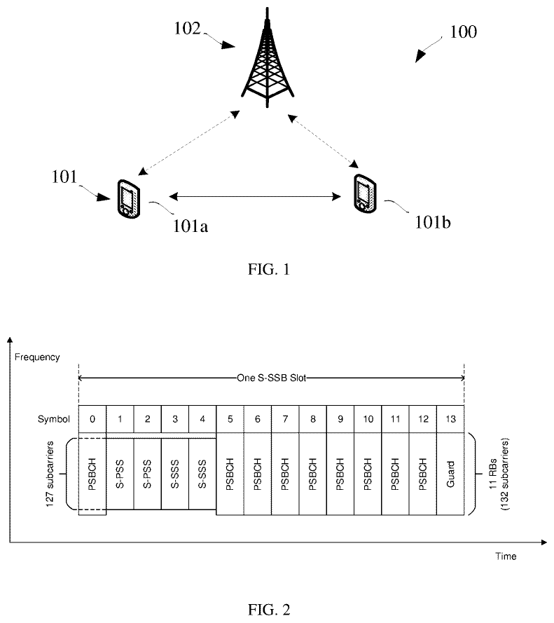

FIG. 1 illustrates an exemplary wireless communication system 100 in accordance with some embodiments of the present application.

As shown in FIG. 1, the wireless communication system 100 includes at least one UE 101 and at least one BS 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

According to some embodiments of the present disclosure, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present disclosure, the UE(s) 101 may include wearable devices, such as smart watches, fitness bands, optical head-mounted displays, or the like.

According to some embodiments of the present disclosure, the UE(s) 101 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present disclosure, a VRU may include a pedestrian UE (P-UE), a cyclist UE, a wheelchair UE or other UEs which require power saving compared with a VUE.

Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In a sidelink communication system, a transmission UE may also be named as a transmitting UE, a Tx UE, a sidelink Tx UE, a sidelink transmission UE, or the like. A reception UE may also be named as a receiving UE, an Rx UE, a sidelink Rx UE, a sidelink reception UE, or the like.

According to some embodiments of FIG. 1, UE 101a functions as a Tx UE, and UE 101b functions as an Rx UE. UE 101a may exchange sidelink messages with UE 101b through a sidelink, for example, via PC5 interface as defined in 3GPP TS 23.303. UE 101a may transmit information or data to other UE(s) within the sidelink communication system, through sidelink unicast, sidelink groupcast, or sidelink broadcast. For instance, UE 101a may transmit data to UE 101b in a sidelink unicast session. UE 101a may transmit data to UE 101b and other UE(s) in a groupcast group (not shown in FIG. 1) by a sidelink groupcast transmission session. Also, UE 101a may transmit data to UE 101b and other UE(s) (not shown in FIG. 1) by a sidelink broadcast transmission session.

Alternatively, according to some other embodiments of FIG. 1, UE 101b functions as a Tx UE and transmits sidelink messages, and UE 101a functions as an Rx UE and receives the sidelink messages from UE 101b.

In some embodiments of the present disclosure, UE 101a may communicate with UE 101b over licensed spectra, whereas in other embodiments, UE 101a may communicate with UE 101b over unlicensed spectra.

Both UE 101a and UE 101b in the embodiments of FIG. 1 may transmit information to BS 102 and receive control information from BS 102, for example, via LTE or NR Uu interface. BS 102 may be distributed over a geographic region. In certain embodiments of the present disclosure, BS 102 may also be referred to as an access point, an access terminal, a base, a base unit, a macro cell, a Node-B, an evolved Node B (eNB), a gNB, a Home Node-B, a relay node, or a device, or described using other terminology used in the art. BS 102 is generally a part of a radio access network that may include one or more controllers communicably coupled to BS 102.

The wireless communication system 100 may be compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

In some embodiments of the present disclosure, the wireless communication system 100 is compatible with the 5G NR of the 3GPP protocol, wherein BS(s) 102 transmit data using an orthogonal frequency division multiplexing (OFDM) modulation scheme on the downlink (DL) and UE(s) 101 transmit data on the uplink (UL) using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS(s) 102 may communicate using other communication protocols, such as the IEEE 802.11 family of wireless communication protocols. Further, in some embodiments of the present disclosure, BS(s) 102 may communicate over licensed spectrums, whereas in other embodiments, BS(s) 102 may communicate over unlicensed spectrums. The present disclosure is not intended to be limited to the implementation of any particular wireless communication system architecture or protocol. In yet some embodiments of the present disclosure, BS(s) 102 may communicate with UE(s) 101 using the 3GPP 5G protocols.

For sidelink transmission, resource allocation may be implemented by two modes, i.e., resource allocation mode 1 and resource allocation mode 2.

In the case of resource allocation mode 1, a sidelink transmission (e.g., a physical sidelink shared channel (PSSCH) transmission and/or a physical sidelink control channel (PSCCH) transmission) can only be carried out by a UE if the UE has been provided with a valid scheduling grant that indicates the exact set of resources used for the sidelink transmission. Resource allocation mode 1 is applicable to the in-coverage deployment scenario.

In the case of resource allocation mode 2, a decision on sidelink transmission, including decision on the exact set of resources to be used for the sidelink transmission, is made by the transmitting UE (also referred to as Tx UE) based on a sensing-based resource (re-)selection procedure. Resource allocation mode 2 is applicable to both in-coverage and out-of-coverage deployment scenarios.

In NR, accommodating multiple uncoordinated UEs in an unlicensed spectrum requires channel access procedures defined for NR. Following a successful channel access procedure performed by a communicating node, the channel can be used by the communicating node during a period until the end of the period. Such a period may be referred to as a channel occupancy time (COT). During a COT, one or more transmissions may be exchanged between the communicating nodes, wherein a transmission may be a downlink transmission or an uplink transmission.

Dynamic channel access procedures are usually used by a BS or a UE to access a channel in an unlicensed spectrum. Dynamic channel access procedures may be based on listen-before-talk (LBT), where a transmitter listens to potential transmission activity on a channel prior to transmitting and applies a random back-off time in some cases. Two main types of dynamic channel access procedures may be defined in NR. One is Type-1 dynamic channel access procedure, which is also referred to as LBT type 1 or LBT cat4. The other is Type-2 dynamic channel access procedure, which is also referred to as LBT type 2.

Type-1 dynamic channel access procedure may be used to initiate data transmission at the beginning of a COT. The initiator for the Type-1 dynamic channel access procedure may be either a BS or a UE. The Type-1 dynamic channel access procedure may be summarized as follows.

First, the initiator listens and waits until a channel (e.g., a frequency channel) is available during at least one period referred to as a defer duration. The defer duration may consist of 16 μs and a number (e.g., “mp” in the following Table 1 or Table 2, which will be illustrated below) of 9 μs slots. As shown in Table 1 and Table 2, a value of “mp” depends on a value of channel access priority class (CAPC) (represented as “p”). Accordingly, the defer duration depends on the value of CAPC as shown in the following Table 1 or Table 2. A channel is declared to be available if the received energy during at least 4 μs of each 9 μs slot is below a threshold.

Once the channel has been declared available during the defer duration, the transmitter starts a random back-off procedure during which it will wait a random period of time.

The UE starts the random back-off procedure by initializing a back-off timer with a random number within a contention window (CW). The random number is drawn from a uniform distribution [0, CW] and represents that the channel must be available for a timer duration (e.g., denoted by the random number multiplying 9 μs) before transmission can take place. The value of “CW” may be selected from “allowed CWₚ sizes” (the minimum value is represented as CWₘᵢₙₚ, and the maximum value is represented as CWₘₐₓₚ) in the following Table 1 or Table 2, which depends on a value of CAPC.

The back-off timer is decreased by one for each sensing slot duration (e.g., 9 μs) the channel is sensed to be idle; whenever the channel is sensed to be busy, the back-off timer is put on hold until the channel has been idle for a defer duration.

Once the back-off timer has expired (e.g., the back-off timer is decreased to be 0), the random back-off procedure is completed, and the transmitter has acquired the channel and can use it for transmission up to MCOT (e.g., T_{mcot,p} in the following Table 1 or T_{ulmcot,p} in the following Table 2, which depends on a value of CAPC).

The following Table 1 and Table 2 illustrate exemplary CAPC for DL and CAPC for UL, respectively, and corresponding values of mₚ, CWₘᵢₙₚ, CWₘₐₓₚ, T_{mcot,p}, T_{ulmot,p}, and allowed CWₚ sizes. Table 1 is the same as Table 4.1.1-1 in, TS 37.213 and Table 2 is the same as Table 4.2.1-1 in TS 37.213. When a BS intends to initiate a channel occupancy for DL transmission, it may determine a CAPC value before performing a Type-1 channel access procedure, and then determine the corresponding values (e.g., mₚ, CWₘᵢₙₚ, CWₘₐₓₚ, T_{mcot,p}, and allowed CWₚ sizes) used in the Type-1 channel access procedure according to Table 1. When a UE intends to initiate a channel occupancy for UL transmission, it may determine a CAPC value before performing a Type-1 channel access procedure, and then determine the corresponding values (e.g., mₚ, CW_{min,p}, CW_{max,p}, T_{ulmcot,p}, and allowed CWₚ sizes) used in the Type-1 channel access procedure according to Table 2.

TABLE 1
Channel Access Priority Class for DL

| Channel | | | | | |
|---|---|---|---|---|---|
| Access | | | | | |
| Priority | | | | | allowed |
| Class (p) | mₚ | CW_{min, p} | CW_{max, p} | T_{mcot, p} | CWₚ sizes |
| 1 | 1 | 3 | 7 | 2 ms | {3, 7} |
| 2 | 1 | 7 | 15 | 3 ms | {7, 15} |
| 3 | 3 | 15 | 63 | 8 or | {15, 31, 63} |
| | | | | 10 ms | |
| 4 | 7 | 15 | 1023 | 8 or | {15, 31, 63, 127, |
| | | | | 10 ms | 255, 511, 1023} |

TABLE 2
Channel Access Priority Class for UL

| Channel | | | | | |
|---|---|---|---|---|---|
| Access | | | | | |
| Priority | | | | | allowed |
| Class (p) | mₚ | CW_{min, p} | CW_{max, p} | T_{ulmcot, p} | CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE1:
For p = 3, 4, T_{ulmcot, p} = 10 ms if the higher layer parameter ‘absenceOfAnyOtherTechnology-r14’ indicates TRUE, otherwise, T_{ulmcot, p} = 6 ms.
NOTE 2:
When T_{ulmcot, p} = 6 ms it may be increased to 8 ms by inserting one or more gaps. The minimum duration of a gap shall be 100 μs. The maximum duration before including any such gap shall be 6 ms.

The size of the contention window may be adjusted based on hybrid automatic repeat request (HARQ) reports received from the transmitter during a reference interval, which covers the beginning of the COT. For each received HARQ report, the contention window is (approximately) doubled up to the limit CW_{max,p} if a negative HARQ report (e.g., non-acknowledgement (NACK)) is received. For a positive HARQ report (e.g., acknowledgement (ACK)), the contention window is reset to its minimum value, i.e., CW=CW_{min,p}.

Type-2 dynamic channel access procedure may be used for COT sharing and transmission of discovery bursts. Depending on a duration of a gap (also referred to as “COT sharing gap”) in the COT, Type-2 dynamic channel access procedure may be further classified into the following three procedures, wherein which procedure to be used may be determined depending on the duration of the gap between two transmission bursts.
Type 2A dynamic channel access procedure (also referred to as LBT cat2 or LBT type 2A): which is used when the gap is 25 μs or more for transmission of the discovery bursts.
Type 2B dynamic channel access procedure (also referred to as LBT type 2B): which is used when the gap is 16 μs.
Type 2C dynamic channel access procedure (also referred to as LBT type 2C): which is used when the gap is 16 μs or less after the preceding transmission burst.

For Type 2C dynamic channel access procedure, no idle sensing is required between the transmission bursts. In such scenario, the duration of a transmission burst is limited to at most 584 μs. Such a short transmission burst may carry small amount of user data, uplink control information (UCI) such as HARQ status reports and channel state information (CSI) reports.

Type 2A dynamic channel access procedure and Type 2B dynamic channel access procedure may be similar to Type-1 dynamic channel access procedure but without the random back-off. That is, in Type 2A dynamic channel access procedure and Type 2B dynamic channel access procedure, if a channel is detected to be idle in the gap, it is declared to be available; if it is detected to be busy, the COT sharing has failed and the transmission cannot occur using COT sharing in this COT. If the COT sharing gap is 16 μs, Type 2B dynamic channel access procedure may be used and the channel must be detected to be idle in the 16 μs gap prior to the next transmission burst. If the COT sharing gap is 25 μs or longer, Type 2A dynamic channel access procedure may be used and the channel must be detected to be idle during at least 25 us immediately preceding the next transmission burst.

The above embodiments provide several dynamic channel access procedures in an unlicensed spectrum for NR. These dynamic channel access procedures may also apply for sidelink transmissions in an unlicensed spectrum.

Sidelink synchronization information is carried in an S-SSB that consists of physical sidelink broadcast channel (PSBCH), sidelink primary synchronization signal (S-PSS) and sidelink secondary synchronization signal (S-SSS). FIG. 2 illustrates an exemplary S-SSB slot according to some embodiments of the present disclosure. In the embodiments of FIG. 2, a normal cyclic prefix (CP) is used.

Referring to FIG. 2, an S-SSB occupies one slot in the time domain and occupies 11 resource blocks (RBs) in the frequency domain. Each RB spans 12 subcarriers, thus the S-SSB bandwidth is 132 (11×12) subcarriers. In the example of FIG. 2, the S-SSB slot may include 14 OFDM symbols in total, e.g., symbol #0 to symbol #13. The S-PSS is transmitted repeatedly on the second and third symbols in the S-SSB slot, e.g., symbol #1 and symbol #2. The S-SSS is transmitted repeatedly on the fourth and fifth symbols in the S-SSB slot, e.g., symbol #3 and symbol #4. The S-PSS and the S-SSS occupy 127 subcarriers in the frequency domain, which are from the third subcarrier relative to the start of the S-SSB bandwidth up to the 129th subcarrier.

The S-PSS and the S-SSS are jointly referred to as the sidelink synchronization signal (SLSS). The SLSS is used for time and frequency synchronization. By detecting the SLSS sent by a synchronization reference UE (also referred to as a SyncRef UE), a UE is able to synchronize to the SyncRef UE and estimate the beginning of the frame and carrier frequency offsets.

The S-PSS may be generated from the maximum length sequences (m-sequences) that use the same design (i.e., generator polynomials, initial values and cyclic shifts, etc.) which is used for generating the m-sequences in the primary synchronization signal (PSS) in the 3GPP documents. In NR Uu, there are three candidate sequences for PSS. However, only two candidate sequences are used for S-PSS.

The S-SSS may be generated from the Gold sequences that use the same design (i.e., generator polynomials, initial values and cyclic shifts, etc.) which is utilized for generating the Gold sequences for the secondary synchronization signal (SSS) in the 3GPP documents. This results in 336 candidate sequences for S-SSS like for the SSS in NR Uu.

For the transmission of SLSS within an S-SSB, a SyncRef UE may select an S-PSS and an S-SSS out of the candidate sequences based on an SLSS identifier (ID). The SLSS ID represents an identifier of the SyncRef UE and conveys a priority of the SyncRef UE as in LTE V2X. Each SLSS ID corresponds to a unique combination of an S-PSS and an S-SSS out of the 2 S-PSS candidate sequences and the 336 S-SSS candidate sequences.

The main purpose of the PSBCH is to provide system-wide information and synchronization information that is required by a UE for establishing a sidelink connection. In the example of FIG. 2, the PSBCH is transmitted on the first symbol (e.g., symbol #0) and the eight symbols (e.g., symbol #5 to symbol #12) after the S-SSS in the S-SSB slot. In the case that an extended CP is used, the PSBCH is transmitted on the first symbol and the six symbols after the S-SSS in the S-SSB slot. The PSBCH occupies 132 subcarriers in the frequency domain. The PSBCH in the first symbol of the S-SSB slot is used for automatic gain control (AGC). The last symbol, e.g., symbol #13, in the S-SSB slot is used as a guard symbol.

A UE may be configured with a configuration for an S-SSB period including one or more S-SSB occasions.

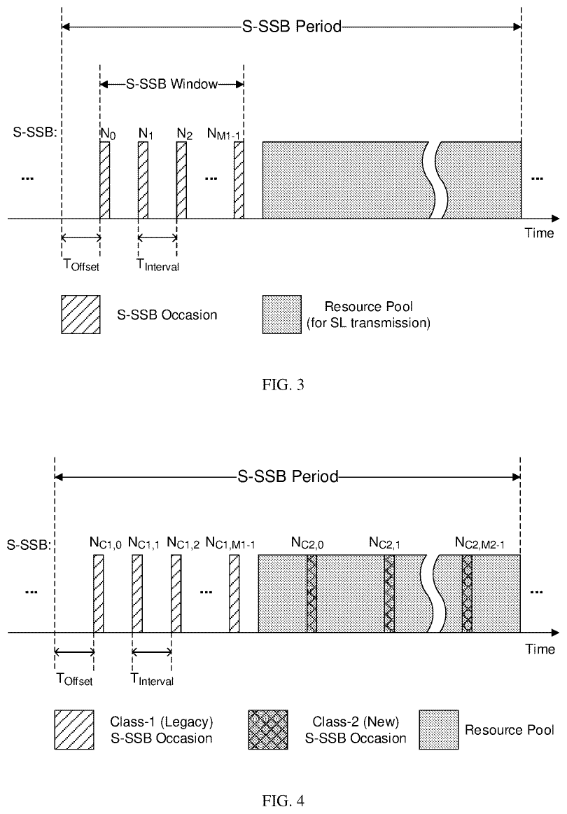

FIG. 3 illustrates an exemplary distribution of S-SSB occasions in the time domain according to some embodiments of the present disclosure.

In FIG. 3, it illustrates an S-SSB period as an example. Referring to FIG. 3, one S-SSB window is included in one S-SSB period. It is contemplated that more S-SSB windows can be included in one S-SSB period in other examples. The S-SSB period may also include resource(s) for SL transmission, which does not overlap with the S-SSB occasions in the time domain. A resource pool may define the overall time and frequency domain resources that can be used for SL transmission within a carrier. In other words, the resource(s) for SL transmission in the S-SSB period is in the resource pool. The SL transmission in the embodiments of the present disclosure may refer to at least one of PSCCH transmission or PSSCH transmission. In the time domain, the resource pool consists of a set of slots repeated over a resource pool period. Although the set of slots within the resource pool are logically organized in a consecutive way, actually the slots within the resource pool may be discretely distributed in the time domain.

As shown in FIG. 3, in the S-SSB window, M1 S-SSB occasions are included, which are S-SSB occasion N₀, S-SSB occasion N₁, S-SSB occasion N₂, . . . , S-SSB occasion N_{M1-1}, respectively.

A length of the S-SSB period is marked as “S-SSB Period” in FIG. 3. There is an offset between the starting of the S-SSB period and the first S-SSB occasion within the S-SSB period, which is marked as “T_{offset}” in FIG. 3. There is an interval between two adjacent S-SSB occasions (e.g., between starting slots of the two adjacent S-SSB occasions), which is marked as “T_{Interval}” in FIG. 3. Accordingly, the configuration for one S-SSB period may include at least one of the parameter “S-SSB Period,” the parameter “T_{Offset},” the parameter “T_{Interval},” or a parameter “M1” indicating the number of S-SSB occasions within one S-SSB window (or one S-SSB period).

In 3GPP Release 16 (Rel-16) or Release 17 (Rel-17), the S-SSB period may include 160 ms, as specified in NR V2X. However, along with developments of network architectures and new service scenarios, the S-SSB period may have other values, which should not affect the principle of the disclosure.

The structure of S-SSB slot in FIG. 2 and distribution of occasions for S-SSB in FIG. 3 are only for illustrative purpose. It is contemplated that along with developments of network architectures and new service scenarios, the S-SSB may have other structures (for example, the S-SSB may include 4 OFDM symbols or 6 OFDM symbols in the time domain) and the distribution of occasions for S-SSB within one S-SSB period or within one S-SSB window may change, which should not affect the principle of the present application.

The S-SSB occasions illustrated in FIG. 3, which are excluded from the resource pool in the time domain, may be referred to as first class S-SSB occasions, class-1 S-SSB occasions, C1 S-SSB occasions, or legacy S-SSB occasions. The distribution of class-1 S-SSB occasions may be denoted by at least one of the following parameters: S-SSB period, T_{offset}, T_{Interval}, or M1 as stated above.

The S-SSB transmissions in unlicensed spectrum may be subject to a channel access procedure as stated above. That is, transmitting an S-SSB on a target S-SSB occasion requires a successful channel access procedure prior to the target S-SSB occasion. The channel access opportunities for transmitting S-SSB in unlicensed spectrum may be reduced due to resource collision or LBT failure. To compensate for the case that some S-SSB occasions are unavailable for transmitting S-SSB, it may be necessary to introduce additional S-SSB occasions for S-SSB transmitting in unlicensed spectrum to achieve the desired amount of channel access opportunities. As an example, the additional S-SSB occasions may be included within the resource pool in the time domain. As another example, the additional S-SSB occasions may be excluded from the resource pool in the time domain but different from the legacy S-SSB occasions. The additional S-SSB occasions may be referred to as second class S-SSB occasions, class-2 S-SSB occasions, C2 S-SSB occasions or new S-SSB occasions.

FIG. 4 illustrates another exemplary distribution of S-SSB occasions in the time domain according to some embodiments of the present disclosure.

The S-SSB occasions illustrated in FIG. 4 may include class-1 S-SSB occasions and class-2 S-SSB occasions. The distribution of the class-1 S-SSB occasions within one S-SSB period may be determined based on at least one of the following parameters: S-SSB period, T_{offset}, T_{Interval}, or M1 as stated above. The distribution of class-2 S-SSB occasions may also be configured or pre-configured to a UE in a similar manner or different manner.

In FIG. 4, each class-1 S-SSB occasion may be indicated by an index of N_{C1,i}, i∈[0, . . . , M1-1], where M1 indicates the total number of class-1 S-SSB occasions within the S-SSB period. Each class-2 S-SSB occasion may be indicated by an index of N_{C2,j}, j∈[0, . . . , M2-1], where M2 indicates the total number of class-2 S-SSB occasions within the S-SSB period.

In FIG. 4, all the class-2 S-SSB occasions may locate after all the class-1 S-SSB occasions within the S-SSB period.

FIG. 5 illustrates yet another exemplary distribution of S-SSB occasions in the time domain according to some embodiments of the present disclosure.

The difference between FIG. 5 and FIG. 4 lies in that: in FIG. 5, not all class-1 S-SSB occasions locate prior to class-2 S-SSB occasions. In some cases, there may be at least one class-2 S-SSB occasion locates prior to a certain class-1 S-SSB occasion within one S-SSB period. In some cases, one or more class-2 S-SSB occasions may locate between class-1 S-SSB occasions within the S-SSB period. Except for the above difference, the descriptions with respect to FIG. 4 may also apply to FIG. 5.

Although the class-2 S-SSB occasions illustrated in FIG. 4 and FIG. 5 are included within the resource pool in the time domain, it is contemplated that some or all of the class-2 S-SSB occasions may be excluded from the resource pool in the time domain in some cases.

Referring to FIGS. 4 and 5, more S-SSB occasions typically result in more time-domain resources required for S-SSB. Therefore, for a certain resource pool, the resources for SL transmission (e.g., at least one of PSSCH transmission or PSCCH transmission) will be reduced due to introducing class-2 S-SSB occasions. To this end, how to efficiently utilize S-SSB resources (especially class-2 S-SSB occasions) is a key issue for sidelink design.

Given the above, embodiments of the present application provide improved solutions for resource allocation for SL transmission and S-SSB transmission in an unlicensed spectrum, which can efficiently utilize S-SSB resources (especially class-2 S-SSB occasions) in unlicensed spectra. More details will be described in the following text in combination with the appended drawings.

In some embodiments of the present application, a Tx UE may refer to a UE intending to transmit S-SSB and apply resource allocation mode 1 to determine resources in unlicensed spectra for S-SSB transmission. In some embodiments of the present application, the Tx UE may be also referred to as a SyncRef UE. In resource allocation mode 1, within an S-SSB period, the Tx UE may transmit information related to S-SSB transmission to a BS, and the BS may determine how to allocate the resources on class-2 S-SSB occasions within the S-SSB period based on the information transmitted from the Tx UE. The purposes of the resource allocation may be for S-SSB transmission and/or for SL transmission. The following embodiments provide multiple principles, related configurations, and procedures regarding how a BS determines resource allocation based on the information related to S-SSB transmission from a Tx UE.

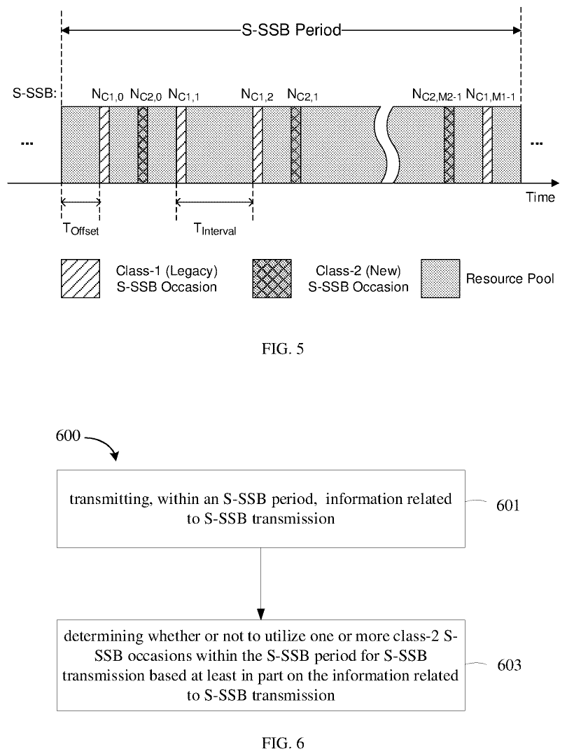

FIG. 6 illustrates a flowchart of an exemplary method 600 for resource allocation in an unlicensed spectrum according to some embodiments of the present application. The method 600 illustrated in FIG. 6 may be performed by a Tx UE (e.g., UE 101a or UE 101b in FIG. 1) or other apparatus with the like functions.

As shown in FIG. 6, in step 601, the UE may transmit, within an S-SSB period, information related to S-SSB transmission to, e.g., a BS (e.g., BS 102 in FIG. 1). The S-SSB period may include class-1 S-SSB occasion(s) and class-2 S-SSB occasion(s). For example, the S-SSB period may be the S-SSB period as shown in FIG. 4 or FIG. 5. The information related to S-SSB transmission may be transmitted on a resource configured, pre-configured, or pre-defined for the UE.

The resource being configured for the UE may refer to that: information indicating the resource may be transmitted by e.g. a BS (e.g., BS 102 as shown in FIG. 1) to the UE via at least one of: a system information block (SIB) message, a master information block (MIB) message, an RRC signaling, a MAC CE, or DCI, such that the UE may receive the information indicating the resource from the BS. In an embodiment of the present application, the resource being configured for the UE may apply to the scenario where the UE is in coverage of a network.

The resource being pre-configured or pre-defined for the UE may refer to that: information indicating the resource may be hard-wired into the UE or stored on a subscriber identity module (SIM) or universal subscriber identity module (USIM) card for the UE, such that the UE may obtain the information indicating the resource within the UE. In an embodiment of the present application, the resource being pre-configured or pre-defined for the UE may apply to the scenario where the UE is out of coverage of the network.

In step 603, the UE may determine whether or not to utilize one or more class-2 S-SSB occasions within the S-SSB period for S-SSB transmission based at least in part on the information related to S-SSB transmission.

The information related to S-SSB transmission may include various contents and thus operations performed by the UE corresponding to different kinds of information related to S-SSB transmission may be different. The following embodiments illustrate examples of different contents included in the information related to S-SSB transmission and the corresponding operations performed by the UE.

### Embodiment 1

In embodiment 1, in the case of resource allocation mode 1, an S-SSB transmission on a class-2 S-SSB occasion can only be carried out (or performed) by a UE in the case that the UE has been provided with a scheduling grant indicating that the class-2 S-SSB occasion is allocated to the UE for S-SSB transmission from the BS.

In embodiment 1, the information related to S-SSB transmission may be a request indicating at least one of:
requesting class-2 S-SSB occasion(s) within the S-SSB period for S-SSB transmission;
requesting a first number of class-2 S-SSB occasion(s) within the S-SSB period for S-SSB transmission: for example, the first number may be denoted by K1, wherein 0<K1≤K_{MAX}, and K_{MAX} is a total number of class-2 S-SSB occasions included in the S-SSB period; or
requesting a first set of class-2 S-SSB occasion(s) within the S-SSB period for S-SSB transmission.

In such embodiment, when the UE intends to transmit S-SSB on class-2 S-SSB occasion(s) within an S-SSB period, the UE may transmit, within the S-SSB period, the request as stated above to the BS in step 601. In some embodiments, the request may be transmitted on a resource dedicated for requesting S-SSB resource.

In some examples, the request may be a one-bit indicator, which indicates that the UE requests class-2 S-SSB occasion(s) within the S-SSB period for S-SSB transmission.

For example, the one-bit indicator may be a scheduling request (SR) dedicated for requesting S-SSB resource, and the resource on which the SR dedicated for requesting S-SSB resource is carried may be different from a resource for transmitting an SR dedicated for requesting resource for SL transmission (e.g., at least one of PSCCH transmission or PSSCH transmission). Based on the different resources, the SR dedicated for requesting S-SSB resource can be differentiated from the SR dedicated for requesting resource for SL transmission.

For example, the one-bit indicator may be transmitted on a physical uplink control channel (PUCCH) resource dedicated for requesting S-SSB resource.

In some other examples, the request may be a multiple-bit indicator. For example, the multiple-bit indicator may be transmitted on a PUCCH resource dedicated for requesting S-SSB resource.

For example, the multiple-bit indicator may indicate a first number (e.g., denoted by K1) of class-2 S-SSB occasion(s) requested by the UE for S-SSB transmission, wherein 0<K1=K_{MAX}, and K_{MAX} is a total number of class-2 S-SSB occasions included in the S-SSB period. The requested class-2 S-SSB occasion(s) may be consecutive S-SSB occasion(s). In the embodiments of the present application, one or more consecutive S-SSB occasions may refer to one or more S-SSB occasions indexed with consecutive integers. The one or more S-SSB occasions may be either consecutive or discrete in the time domain, subject to the configuration of distribution.

In another example, the multiple-bit indicator may indicate a first set of class-2 S-SSB occasion(s) within the S-SSB period requested by the UE for S-SSB transmission. For example, the multiple-bit indicator may be a bitmap including K_{MAX} bits, wherein each bit corresponds to a class-2 S-SSB occasion of the K_{MAX} class-2 S-SSB occasions included in the S-SSB period and indicates whether or not the corresponding class-2 S-SSB occasion is requested by the UE for S-SSB transmission. In the embodiments of the present application, a set of S-SSB occasion(s) may include at least one S-SSB occasion. That is, the set of S-SSB occasion(s) may include one or more S-SSB occasions.

Within the same S-SSB period, the UE may receive or may not receive a response from e.g. the BS. Based on whether the UE receives a response, embodiment 1 may further include the following two cases.

### Case 1

In case 1, the UE may receive a response in response to the request transmitted in step 601. The response may indicate allocated class-2 S-SSB occasion(s) to the UE for S-SSB transmission. Then, in step 603, the UE may determine to utilize the allocated class-2 S-SSB occasion(s) within the S-SSB period for S-SSB transmission.

In some embodiments, the response may be received via at least one of: DCI, a MAC CE, or a RRC signaling from e.g. the BS.

In some embodiments, the response may indicate at least one of:
whether the UE can utilize all class-2 S-SSB occasion(s) within the S-SSB period located after a resource on which the response is carried for S-SSB transmission;
whether the UE can utilize class-2 S-SSB occasion(s) requested by the UE for S-SSB transmission;
a second number of class-2 S-SSB occasion(s) within the S-SSB period allocated to the UE for S-SSB transmission: for example, the second number may be denoted by K2, wherein 0<K2≤K_{MAX}, and K_{MAX} is a total number of class-2 S-SSB occasions included in the S-SSB period; or
a second set of class-2 S-SSB occasion(s) within the S-SSB period allocated to the UE for S-SSB transmission.

In an embodiment, the response may be a one-bit indicator, which indicates whether the UE can utilize all class-2 S-SSB occasion(s) within the S-SSB period located after a resource on which the response is carried for S-SSB transmission. In such embodiment, in the case that the one-bit indicator indicates that the UE can utilize all class-2 S-SSB occasion(s) within the S-SSB period located after the resource on which the response is carried for S-SSB transmission, in step 603, the UE may determine to utilize all class-2 S-SSB occasion(s) within the S-SSB period located after the resource on which the response is carried for S-SSB transmission; otherwise, in step 603, the UE may determine not to utilize all class-2 S-SSB occasion(s) within the S-SSB period located after the resource on which the response is carried for S-SSB transmission.

In another embodiment, the response may be a one-bit indicator, which indicates whether the UE can utilize class-2 S-SSB occasion(s) requested by the UE for S-SSB transmission. In such embodiment, in the case that the one-bit indicator indicates that the UE can utilize class-2 S-SSB occasion(s) requested by the UE for S-SSB transmission (e.g., K1 (consecutive) class-2 S-SSB occasion(s) within the S-SSB period or the first set of class-2 S-SSB occasion(s) within the S-SSB period), in step 603, the UE may determine to utilize class-2 S-SSB occasion(s) requested by the UE (e.g., K1 (consecutive) class-2 S-SSB occasion(s) within the S-SSB period, wherein a first one of the K1 (consecutive) class-2 S-SSB occasion(s) is located after an offset relative to a resource on which the response is carried, for example, the first one of the K1 (consecutive) class-2 S-SSB occasion(s) is the first class-2 S-SSB occasion which locates after the offset relative to the resource on which the response is carried, the offset may be configured, pre-configured, or pre-defined for the UE, the offset may be in units of slot or ms, and the offset may be greater than or equal to zero; or the first set of class-2 S-SSB occasion(s) within the S-SSB period) for S-SSB transmission; otherwise, in step 603, the UE may determine not to utilize class-2 S-SSB occasion(s) requested by the UE for S-SSB transmission.

In another embodiment, the response may be a multiple-bit indicator, which indicates a second number (e.g., denoted by K2) of class-2 S-SSB occasion(s) within the S-SSB period allocated to the UE for S-SSB transmission, wherein 0<K2≤K_{MAX}, and K_{MAX} is a total number of class-2 S-SSB occasions included in the S-SSB period. K2 may be the same as or different from K1.

In such embodiment, after receiving the response, in step 603, the UE may determine to utilize K2 (consecutive) class-2 S-SSB occasion(s) within the S-SSB period for S-SSB transmission, wherein a first one of the K2 (consecutive) class-2 S-SSB occasion(s) is located after an offset relative to a resource on which the response is carried. In some cases, the first one of the K2 (consecutive) class-2 S-SSB occasion(s) is the first class-2 S-SSB occasion which locates after the offset relative to the resource on which the response is carried. In some cases, the offset may be in units of slot or ms. In some cases, the offset may be greater than or equal to zero. The offset may be configured, pre-configured, or pre-defined for the UE, or the response may further indicate the offset. The aforementioned definitions regarding “configured,” “pre-configured,” and “pre-defined” may also apply here.

In another embodiment, the response may be a multiple-bit indicator, which indicates a second set of class-2 S-SSB occasion(s) within the S-SSB period allocated to the UE for S-SSB transmission. For example, the multiple-bit indicator may be a bitmap including K_{MAX} bits, wherein each bit corresponds to a class-2 S-SSB occasion of the K_{MAX} class-2 S-SSB occasions included in the S-SSB period and indicates whether or not the corresponding class-2 S-SSB occasion is allocated to the UE for S-SSB transmission. The second set of class-2 S-SSB occasion(s) may be the same as or different from the first set of class-2 S-SSB occasion(s).

In such example, after receiving the response, in step 603, the UE may determine to utilize the second set of class-2 S-SSB occasion(s) within the S-SSB period for S-SSB transmission.

### Case 2

In case 2, the UE may determine to utilize requested class-2 S-SSB occasion(s) within the S-SSB period for S-SSB transmission without any confirmation from the BS. That is, the UE may not receive a response in response to the request transmitted in step 601. In such case, the UE may determine whether to utilize one or more class-2 S-SSB occasions within the S-SSB period for S-SSB transmission based on the request as stated above.

For example, in the case that the request indicates requesting class-2 S-SSB occasion(s) for S-SSB transmission, the UE may determine to utilize all class-2 S-SSB occasion(s) within the S-SSB period located after an offset relative to the resource on which the request is carried for S-SSB transmission. The offset may be in units of slot or ms. The offset may be greater than or equal to zero. The offset may be configured, pre-configured, or pre-defined for the UE. The above definitions regarding “configured,” “pre-configured,” and “pre-defined” may also apply here.

In another example, in the case that the request indicates requesting the first number of class-2 S-SSB occasion(s), the UE may determine to utilize the first number of (consecutive) class-2 S-SSB occasion(s) within the S-SSB period for S-SSB transmission, wherein a first one of the first number of (consecutive) class-2 S-SSB occasion(s) is located after an offset relative to the resource on which the request is carried. In some cases, the first one of the first number of (consecutive) class-2 S-SSB occasion(s) is the first class-2 S-SSB occasion which locates after the offset relative to the resource on which the request is carried. In some cases, the offset may be in units of slot or ms. In some cases, the offset may be greater than or equal to zero. The offset may be configured, pre-configured, or pre-defined to the UE. The above definitions regarding “configured,” “pre-configured,” and “pre-defined” may also apply here.

In yet another example, in the case that the request indicates requesting the first set of class-2 S-SSB occasion(s), the UE may determine to utilize the first set of class-2 S-SSB occasion(s) within the S-SSB period for S-SSB transmission.

### Embodiment 2

In embodiment 2, in the case of resource allocation mode 1, an S-SSB transmission on a class-2 S-SSB occasion can be carried out (or performed) by a UE without a scheduling grant from a BS if the UE has reported a failure of transmission(s) on class-1 S-SSB occasion(s) to the BS.

In embodiment 2, the information related to S-SSB transmission may be a first indicator related to a failure of transmission(s) on at least one class-1 S-SSB occasion within the S-SSB period. In such embodiments, after a UE has tried S-SSB transmission(s) on the at least one class-1 S-SSB occasion within the S-SSB period, the UE may transmit, within the S-SSB period, the first indicator related to a failure of transmission(s) on the at least one class-1 S-SSB occasion to the BS in step 601.

The first indicator may indicate at least one of: a failure of transmission(s) on the at least one class-1 S-SSB occasion within the S-SSB period; or an index of a class-1 S-SSB occasion within the S-SSB period on which a failure of transmission occurs. In some embodiments, a failure of transmission on a class-1 S-SSB occasion may include at least one of: an LBT failure on the class-1 S-SSB occasion; or an S-SSB not successfully transmitted on the class-1 S-SSB occasion.

In embodiment 2, the UE may obtain a linkage which defines a mapping relationship between class-1 S-SSB occasion(s) and class-2 S-SSB occasion(s) within the S-SSB period. In some embodiments, the linkage may be based on at least one of the following granularities: per resource pool or per SCS. In some embodiments, the linkage may be configured, pre-configured, or pre-defined for the UE. The above definitions regarding “configured,” “pre-configured,” and “pre-defined” may also apply here.

In step 603, the UE may determine to utilize a set of class-2 S-SSB occasion(s) corresponding to the at least one class-1 S-SSB occasion on which a failure of transmission(s) is reported by the UE based on the mapping relationship defined by the linkage. The specific operations in step 603 will be described below.

In some examples, the first indicator may indicate a failure of transmission(s) on the at least one class-1 S-SSB occasion within the S-SSB period. For example, the first indicator may be a one-bit indicator. In such embodiments, the linkage may indicate a third number (e.g., denoted by K3) of (consecutive) class-2 S-SSB occasion(s), wherein 0<K3≤K_{MAX}, and K_{MAX} is a total number of class-2 S-SSB occasions included in the S-SSB period. The UE may determine to utilize the third number of (consecutive) class-2 S-SSB occasion(s) within the S-SSB period for S-SSB transmission, wherein a first one of the third number of (consecutive) class-2 S-SSB occasion(s) is located after an offset relative to a resource on which the first indicator is carried. In some cases, the first one of the third number of (consecutive) class-2 S-SSB occasion(s) is the first class-2 S-SSB occasion which locates after the offset relative to the resource on which the first indicator is carried. In some cases, the offset may be in units of slot or ms. In some cases, the offset may be greater than or equal to zero. The offset may be configured, pre-configured, or pre-defined for the UE, or the linkage may further indicate the offset. The above definitions regarding “configured,” “pre-configured,” and “pre-defined” may also apply here.

In some other examples, the first indicator may indicate an index of a class-1 S-SSB occasion within the S-SSB period on which a failure of transmission occurs, and the linkage may indicate a fourth number (e.g., denoted by K4) of (consecutive) class-2 S-SSB occasion(s), wherein 0<K4<K_{MAX}, and K_{MAX} is a total number of class-2 S-SSB occasions included in the S-SSB period. The UE may determine to utilize the fourth number of (consecutive) class-2 S-SSB occasion(s) within the S-SSB period for S-SSB transmission, wherein a first one of the fourth number of (consecutive) class-2 S-SSB occasion(s) is located after an offset relative to a location of the class-1 S-SSB occasion on which the failure of transmission occurs. In some cases, the first one of the fourth number of (consecutive) class-2 S-SSB occasion(s) is the first class-2 S-SSB occasion which locates after the offset relative to the location of the class-1 S-SSB occasion on which the failure of transmission occurs. In some cases, the offset may be in units of slot or ms. In some cases, the offset may be greater than or equal to zero. The offset may be configured, pre-configured, or pre-defined for the UE, or the linkage may further indicate the offset. The above definitions regarding “configured,” “pre-configured,” and “pre-defined” may also apply here.

In some other examples, the first indicator may indicate an index of a class-1 S-SSB occasion within the S-SSB period on which a failure of transmission occurs, and the linkage may be a lookup table including at least one entry, wherein each of the at least one entry indicates a mapping between an index of a class-1 S-SSB occasion and an associated set of class-2 S-SSB occasion(s) within the S-SSB period. The UE may determine to utilize a set of class-2 S-SSB occasion(s) associated with the class-1 S-SSB occasion indicated by the first indicator for S-SSB transmission based on the lookup table.

### Embodiment 3

In embodiment 3, in the case of resource allocation mode 1, a BS may assume (or determine) that class-2 S-SSB occasion(s) in an S-SSB period will be used for S-SSB transmission until receiving an indicator from the UE indicating that the class-2 S-SSB occasion(s) will be released.

In embodiment 3, the information related to S-SSB transmission may be a second indicator indicating a release of class-2 S-SSB occasion(s). In such embodiments, the UE may transmit, within an S-SSB period, the second indicator indicating a release of class-2 S-SSB occasion(s) to the BS in step 601.

In some embodiments, the second indicator may be transmitted in response to at least one of the following conditions: the UE has successfully performed S-SSB transmission(s) on class-1 S-SSB occasion(s) within the S-SSB period; the UE has successfully performed S-SSB transmission(s) on first N1 S-SSB occasion(s) within the S-SSB period, wherein 0<N1≤N_{MAX}, and N_{MAX} is a total number of S-SSB occasions included in the S-SSB period; the UE decides not to transmit S-SSB; the UE detects successful S-SSB transmission(s) performed by other UE(s) on class-1 S-SSB occasion(s) within the S-SSB period; or the UE detects successful S-SSB transmission(s) performed by other UE(s) on first N2 S-SSB occasion(s) within the S-SSB period, wherein 0<N2≤N_{MAX}.

In step 603, the UE may determine not to utilize one or more class-2 S-SSB occasion(s) within the S-SSB period for S-SSB transmission based on the second indicator. The specific operations in step 603 may be as follows.

In some embodiments, the second indicator may indicate a release of class-2 S-SSB occasion(s) within the S-SSB period. For example, a release of class-2 S-SSB occasion(s) within the S-SSB period may include: a release of all class-2 S-SSB occasions within the S-SSB period, a release of all class-2 S-SSB occasion(s) subsequent to the resource on which the second indicator is carried within the S-SSB period, or a release of class-2 S-SSB occasion(s) that has not been utilized by the UE within the S-SSB period. In such embodiments, the UE may determine not to utilize the released class-2 S-SSB occasion(s) indicated by the second indicator for S-SSB transmission.

Alternatively or additionally, the second indicator may indicate a release of a number (e.g., denoted by K5) of class-2 S-SSB occasion(s) within the S-SSB period, wherein 0<K5≤K_{MAX}, and K_{MAX} is a total number of class-2 S-SSB occasions included in the S-SSB period. In such embodiment, the UE may determine not to utilize K5 (consecutive) class-2 S-SSB occasion(s) within the S-SSB period for S-SSB transmission, wherein the K5 (consecutive) class-2 S-SSB occasion(s) are located after the resource on which the second indicator is carried.

Alternatively or additionally, the second indicator may indicate a release of a set of class-2 S-SSB occasion(s) within the S-SSB period. In such embodiment, the UE may determine not to utilize the set of class-2 S-SSB occasion(s) within the S-SSB period for S-SSB transmission. For example, the second indicator may be a bitmap including K_{MAX} bits, wherein each bit corresponds to a class-2 S-SSB occasion of the K_{MAX} class-2 S-SSB occasions included in the S-SSB period and indicates whether or not the corresponding class-2 S-SSB occasion is to be release.

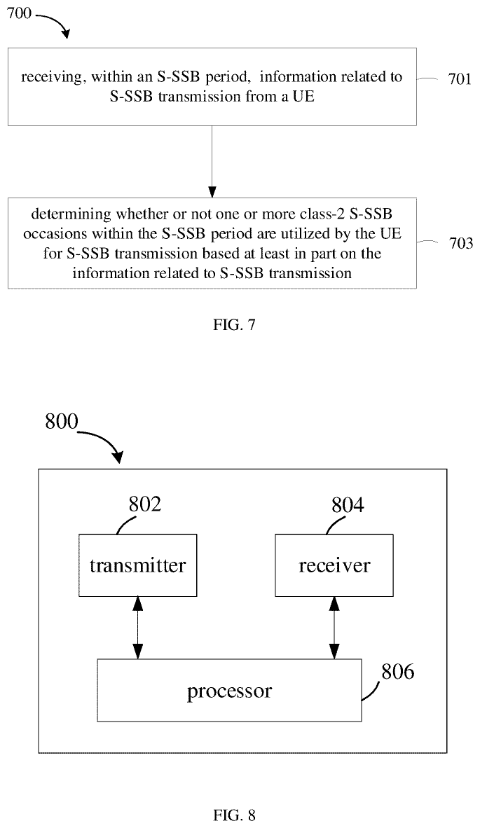

FIG. 7 illustrates a flowchart of an exemplary method 700 for resource allocation in an unlicensed spectrum according to some other embodiments of the present application. The method 700 illustrated in FIG. 7 may be performed by a BS (e.g., BS 102 in FIG. 1) or other apparatus with the like functions.

As shown in FIG. 7, in step 701, the BS may receive, within an S-SSB period, information related to S-SSB transmission from a UE (e.g., UE 101a or UE 101b in FIG. 1). The S-SSB period may include class-1 S-SSB occasion(s) and class-2 S-SSB occasion(s). For example, the S-SSB period may be the S-SSB period as shown in FIG. 4 or FIG. 5. The information related to S-SSB transmission may be received on a resource configured, pre-configured, or pre-defined for the UE.

In step 703, the BS may determine whether or not one or more class-2 S-SSB occasions within the S-SSB period are utilized by the UE for S-SSB transmission based at least in part on the information related to S-SSB transmission.

The specific operations in steps 701 and 703 will be described below.

### Embodiment 1′

In embodiment 1′, in the case of resource allocation mode 1, an S-SSB transmission on a class-2 S-SSB occasion can only be carried out (or performed) by a UE in the case that the UE has been provided with a scheduling grant indicating that the class-2 S-SSB occasion is allocated to the UE for S-SSB transmission from the BS.

In embodiment 1′, the information related to S-SSB transmission may be a request indicating at least one of:
requesting class-2 S-SSB occasion(s) within the S-SSB period for S-SSB transmission;
requesting a first number of class-2 S-SSB occasion(s) within the S-SSB period for S-SSB transmission: for example, the first number may be denoted by K1, wherein 0<K1≤K_{MAX}, and K_{MAX} is a total number of class-2 S-SSB occasions included in the S-SSB period; or
requesting a first set of class-2 S-SSB occasion(s) within the S-SSB period for S-SSB transmission.

In some examples of embodiment 1′, in step 701, the BS may receive, within an S-SSB period, the request as stated above from the UE. All the definitions regarding the request in embodiment 1 may also apply here.

After receiving the request, the BS may determine the resource allocation, and may or may not transmit a response to the UE within the same S-SSB period. Based on whether the BS transmits a response to the UE in response to the request received in step 701, embodiment 1′ may further include the following two cases.

### Case 1′

In case 1′, the BS may transmit a response to the UE in response to the request received in step 701. The response may indicate allocated class-2 S-SSB occasion(s) to the UE for S-SSB transmission. Then, in step 703, the BS may determine that the allocated class-2 S-SSB occasion(s) within the S-SSB period are utilized by the UE for S-SSB transmission.

In some embodiments, the response may be transmitted via at least one of: DCI, a MAC CE, or a RRC signaling.

In some embodiments, the response may indicate at least one of:
whether the UE can utilize all class-2 S-SSB occasion(s) within the S-SSB period located after a resource on which the response is carried for S-SSB transmission;
whether the UE can utilize class-2 S-SSB occasion(s) requested by the UE for S-SSB transmission;
a second number of class-2 S-SSB occasion(s) within the S-SSB period allocated to the UE for S-SSB transmission: for example, the second number may be denoted by K2, wherein 0<K2≤K_{MAX}, and K_{MAX} is a total number of class-2 S-SSB occasions included in the S-SSB period; or.
a second set of class-2 S-SSB occasion(s) within the S-SSB period allocated to the UE for S-SSB transmission.

In an embodiment, the response may be a one-bit indicator, which indicates whether the UE can utilize all class-2 S-SSB occasion(s) within the S-SSB period located after a resource on which the response is carried for S-SSB transmission. In such embodiment, in the case that the one-bit indicator indicates that the UE can utilize all class-2 S-SSB occasion(s) within the S-SSB period located after the resource on which the response is carried for S-SSB transmission, in step 703, the BS may determine that all class-2 S-SSB occasion(s) within the S-SSB period located after the resource on which the response is carried are utilized by the UE for S-SSB transmission; otherwise, in step 703, the BS may determine that all class-2 S-SSB occasion(s) within the S-SSB period located after the resource on which the response is carried are not utilized by the UE for S-SSB transmission.

In another embodiment, the response may be a one-bit indicator, which indicates whether the UE can utilize class-2 S-SSB occasion(s) requested by the UE for S-SSB transmission. In such embodiment, in the case that the one-bit indicator indicates that the UE can utilize class-2 S-SSB occasion(s) requested by the UE for S-SSB transmission (e.g., K1 (consecutive) class-2 S-SSB occasion(s) within the S-SSB period or the first set of class-2 S-SSB occasion(s) within the S-SSB period), in step 703, the BS may determine that class-2 S-SSB occasion(s) requested by the UE are utilized by the UE (e.g., K1 (consecutive) class-2 S-SSB occasion(s) within the S-SSB period, wherein a first one of the K1 (consecutive) class-2 S-SSB occasion(s) is located after an offset relative to a resource on which the response is carried, for example, the first one of the K1 (consecutive) class-2 S-SSB occasion(s) is the first class-2 S-SSB occasion which locates after the offset relative to the resource on which the response is carried, the offset may be in units of slot or ms, and the offset may be greater than or equal to zero; or the first set of class-2 S-SSB occasion(s) within the S-SSB period) for S-SSB transmission; otherwise, in step 703, the BS may determine that class-2 S-SSB occasion(s) requested by the UE are not utilized by the UE for S-SSB transmission.

In another embodiment, the response may be a multiple-bit indicator, which indicates a second number (e.g., denoted by K2) of class-2 S-SSB occasion(s) within the S-SSB period allocated to the UE for S-SSB transmission, wherein 0<K2≤K_{MAX}, and K_{MAX} is a total number of class-2 S-SSB occasions included in the S-SSB period. K2 may be the same as or different from K1.

In such embodiment, in step 703, the BS may determine that K2 (consecutive) class-2 S-SSB occasion(s) within the S-SSB period are utilized by the UE for S-SSB transmission, wherein a first one of the K2 (consecutive) class-2 S-SSB occasion(s) is located after an offset relative to a resource on which the response is carried. In some cases, the first one of the K2 (consecutive) class-2 S-SSB occasion(s) is the first class-2 S-SSB occasion which locates after the offset relative to the resource on which the response is carried. In some cases, the offset may be in units of slot or ms. In some cases, the offset may be greater than or equal to zero.

In another embodiment, the response may be a multiple-bit indicator, which indicates a second set of class-2 S-SSB occasion(s) within the S-SSB period allocated to the UE for S-SSB transmission. For example, the multiple-bit indicator may be a bitmap including K_{MAX} bits, wherein each bit corresponds to a class-2 S-SSB occasion of the K_{MAX} class-2 S-SSB occasions included in the S-SSB period and indicates whether or not the corresponding class-2 S-SSB occasion is allocated to the UE for S-SSB transmission. The second set of class-2 S-SSB occasion(s) may be the same as or different from the first set of class-2 S-SSB occasion(s).

In such example, in step 703, the BS may determine that the second set of class-2 S-SSB occasion(s) within the S-SSB period are utilized by the UE for S-SSB transmission.

### Case 2′

In case 2′, the BS may transmit no confirmation for requested class-2 S-SSB occasion(s) within the S-SSB period to the UE. That is, the BS may not transmit a response to the UE in response to the request received in step 701. In such case, the BS may determine whether one or more class-2 S-SSB occasions within the S-SSB period are utilized by the UE for S-SSB transmission based on the request as stated above.

For example, in the case that the request indicates requesting class-2 S-SSB occasion(s) for S-SSB transmission, the BS may determine that all class-2 S-SSB occasion(s) within the S-SSB period located after an offset relative to the resource on which the request is carried are utilized by the UE for S-SSB transmission. In some cases, the offset may be in units of slot or ms. In some cases, the offset may be greater than or equal to zero.

In another example, in the case that the request indicates requesting the first number of class-2 S-SSB occasion(s), the BS may determine that the first number of (consecutive) class-2 S-SSB occasion(s) within the S-SSB period are utilized by the UE for S-SSB transmission, wherein a first one of the first number of (consecutive) class-2 S-SSB occasions is located after an offset relative to the resource on which the request is carried. In some cases, the first one of the first number of (consecutive) class-2 S-SSB occasion(s) is the first class-2 S-SSB occasion which locates after the offset relative to the resource on which the request is carried. In some cases, the offset may be in units of slot or ms. In some cases, the offset may be greater than or equal to zero.

In yet another example, in the case that the request indicates requesting the first set of class-2 S-SSB occasion(s), the BS may determine that the first set of class-2 S-SSB occasion(s) within the S-SSB period are utilized by the UE for S-SSB transmission.

In some examples of embodiment 1′, in the case that the BS does not receive a request as described above from any UE within an S-SSB period, the BS may allocate remaining class-2 S-SSB occasion(s) for SL transmission purpose.

For example, in the case that the BS receives no request for class-2 S-SSB occasion(s) within the S-SSB period for S-SSB transmission up to a time point within the S-SSB period, the BS may determine that all remaining class-2 S-SSB occasion(s) within the S-SSB period can be allocated for SL transmission.

In some embodiments, the time point may be after first N3 S-SSB occasion(s) within the S-SSB period, wherein 0<N3≤N_{MAX}, and N_{MAX} is a total number of S-SSB occasions included in the S-SSB period. The first N3 S-SSB occasion(s) may include at least one of: one or more class-1 S-SSB occasion(s) or one or more class-2 S-SSB occasion(s). For example, the time point may be a slot right after a slot where the N3-th S-SSB occasion locates.

For example, in the case that all class-2 S-SSB occasions locate after all class-1 S-SSB occasions within the S-SSB period, as illustrated in FIG. 4, if the BS receives no request for class-2 S-SSB occasion(s) within the S-SSB period for S-SSB transmission prior to the first class-2 S-SSB occasion (e.g., prior to a starting time point of the first class-2 S-SSB occasion) within the S-SSB period, the BS may determine that all class-2 S-SSB occasion(s) within the S-SSB period can be allocated for SL transmission. How to allocate the class-2 S-SSB occasion(s) within the S-SSB period may be the BS's implementation. In such example, N3 equals a total number of class-1 S-SSB occasions included in the S-SSB period.

### Embodiment 2′

In embodiment 2′, in the case of resource allocation mode 1, an S-SSB transmission on a class-2 S-SSB occasion can be carried out (or performed) by a UE without a scheduling grant from the BS if the UE has reported a failure of transmission(s) on class-1 S-SSB occasion(s) to the BS.

In embodiment 2′, the information related to S-SSB transmission may be a first indicator related to a failure of transmission(s) on at least one class-1 S-SSB occasion within the S-SSB period. In such embodiments, the BS may receive, within the S-SSB period, the first indicator related to a failure of transmission(s) on the at least one class-1 S-SSB occasion from the UE in step 701.

All the definitions regarding the first indicator in embodiment 2 may also apply here.

After receiving the first indicator from the UE, the BS may transmit no confirmation (or response) to the UE and assume that the UE will attempt to use a set of class-2 S-SSB occasion(s) for S-SSB transmission as indicated by a linkage defining a mapping relationship between class-1 S-SSB occasion(s) and class-2 S-SSB occasion(s) within the S-SSB period.

For example, in step 703, the BS may determine, based on the mapping relationship defined by the linkage, that a set of class-2 S-SSB occasions corresponding to the at least one class-1 S-SSB occasion a failure of transmission(s) on which is reported by the UE is utilized by the UE for S-SSB transmission. All the definitions regarding the linkage in embodiment 2 may also apply here.

The specific operations in step 703 will be described below.

In some examples, the first indicator may indicate a failure of transmission(s) on the at least one class-1 S-SSB occasion within the S-SSB period. For example, the first indicator may be a one-bit indicator. In such embodiments, the linkage may indicate a third number (e.g., denoted by K3) of (consecutive) class-2 S-SSB occasion(s), wherein 0<K3≤K_{MAX}, and K_{MAX} is a total number of class-2 S-SSB occasions included in the S-SSB period. The BS may determine that the third number of (consecutive) class-2 S-SSB occasion(s) within the S-SSB period are utilized by the UE for S-SSB transmission, wherein a first one of the third number of (consecutive) class-2 S-SSB occasion(s) is located after an offset relative to a resource on which the first indicator is carried. In some cases, the first one of the third number of (consecutive) class-2 S-SSB occasion(s) is the first class-2 S-SSB occasion which locates after the offset relative to the resource on which the first indicator is carried. In some cases, the offset may be in units of slot or ms. In some cases, the offset may be greater than or equal to zero.

In some other examples, the first indicator may indicate an index of a class-1 S-SSB occasion within the S-SSB period on which a failure of transmission occurs, and the linkage may indicate a fourth number (e.g., denoted by K4) of (consecutive) class-2 S-SSB occasion(s), wherein 0<K4≤K_{MAX}, and K_{MAX} is a total number of class-2 S-SSB occasions included in the S-SSB period. The BS may determine that the fourth number of (consecutive) class-2 S-SSB occasion(s) within the S-SSB period are utilized by the UE for S-SSB transmission, wherein a first one of the fourth number of (consecutive) class-2 S-SSB occasion(s) is located after an offset relative to a location of the class-1 S-SSB occasion on which the failure of transmission occurs. In some cases, the first one of the fourth number of (consecutive) class-2 S-SSB occasion(s) is the first class-2 S-SSB occasion which locates after the offset relative to the location of the class-1 S-SSB occasion on which the failure of transmission occurs. In some cases, the offset may be in units of slot or ms. In some cases, the offset may be greater than or equal to zero.

In some other examples, the first indicator may indicate an index of a class-1 S-SSB occasion within the S-SSB period on which a failure of transmission occurs, and the linkage may be a lookup table including at least one entry, wherein each of the at least one entry indicates a mapping between an index of a class-1 S-SSB occasion and an associated set of class-2 S-SSB occasion(s) within the S-SSB period. The BS may determine that a set of class-2 S-SSB occasion(s) associated with the class-1 S-SSB occasion indicated by the first indicator according to the lookup table are utilized by the UE for S-SSB transmission.

Embodiment 3′

In embodiment 3′, in the case of resource allocation mode 1, the BS may assume (or determine) that class-2 S-SSB occasion(s) in an S-SSB period will be used for S-SSB transmission until receiving an indicator from the UE indicating that the class-2 S-SSB occasion(s) will be released.

In embodiment 3′, the information related to S-SSB transmission may be a second indicator indicating a release of class-2 S-SSB occasion(s). In such embodiments, the BS may receive, within an S-SSB period, the second indicator indicating a release of class-2 S-SSB occasion(s) in step 701.

After receiving the second indicator from the UE, the BS may transmit no confirmation (or response) to the UE and assume that the released class-2 S-SSB occasion(s) indicated by the second indicator are not utilized by the UE for S-SSB transmission. It is determined by the BS itself how to allocate the released class-2 S-SSB occasion(s) for other purpose (e.g., for SL transmission).

For example, in step 703, the BS may determine that the released class-2 S-SSB occasion(s) indicated by the second indicator are not utilized by the UE for S-SSB transmission. The specific operations in step 703 may be as follows.

In some embodiments, the second indicator may indicate a release of class-2 S-SSB occasion(s) within the S-SSB period. For example, a release of class-2 S-SSB occasion(s) within the S-SSB period may include: a release of all class-2 S-SSB occasions within the S-SSB period, a release of all class-2 S-SSB occasion(s) subsequent to the resource on which the second indicator is carried within the S-SSB period, or a release of class-2 S-SSB occasion(s) that has not been utilized by the UE within the S-SSB period. In such embodiments, the BS may determine that the released class-2 S-SSB occasion(s) indicated by the second indicator are not utilized by the UE for S-SSB transmission.

Alternatively or additionally, the second indicator may indicate a release of a number (e.g., denoted by K5) of class-2 S-SSB occasion(s) within the S-SSB period, wherein 0<K5≤K_{MAX}, and K_{MAX} is a total number of class-2 S-SSB occasions included in the S-SSB period. In such embodiment, the BS may determine that K5 (consecutive) class-2 S-SSB occasion(s) within the S-SSB period are not utilized by the UE for S-SSB transmission, wherein the K5 (consecutive) class-2 S-SSB occasion(s) are located after the resource on which the second indicator is carried.

Alternatively or additionally, the second indicator may indicate a release of a set of class-2 S-SSB occasion(s) within the S-SSB period. In such embodiment, the BS may determine that the set of class-2 S-SSB occasion(s) within the S-SSB period are not utilized by the UE for S-SSB transmission. For example, the second indicator may be a bitmap including K_{MAX} bits, wherein each bit corresponds to a class-2 S-SSB occasion of the K_{MAX} class-2 S-SSB occasions included in the S-SSB period and indicates whether or not the corresponding class-2 S-SSB occasion is to be release.

For resource allocation mode 1, in some cases, an Rx UE may perform detection for S-SSB transmission or for SL transmission on class-2 S-SSB occasion(s). In some embodiments of the present application, the Rx UE may perform detection on class-2 S-SSB occasion(s) within an S-SSB period based on the detection results on class-1 S-SSB occasion(s) within the same S-SSB period.

For example, in the case that S-SSB transmission(s) has been detected on class-1 S-SSB occasion(s) within an S-SSB period by the UE, the UE may perform detection for SL transmission (e.g., at least one of PSCCH transmission or PSSCH transmission) on the remaining class-2 S-SSB occasion(s) within the S-SSB period.

For example, in the case that S-SSB transmission(s) has not been detected on class-1 S-SSB occasion(s) within an S-SSB period by the UE, the UE may assume that the remaining class-2 S-SSB occasion(s) within the S-SSB period will be used for S-SSB transmission and may perform detection for S-SSB transmission on the remaining class-2 S-SSB occasion(s) within the S-SSB period.

FIG. 8 illustrates a simplified block diagram of an exemplary apparatus 800 for resource allocation in an unlicensed spectrum according to some embodiments of the present application. In some embodiments, the apparatus 800 may be or include at least part of a Tx UE (e.g., UE 101a or UE 101b in FIG. 1). In some other embodiments, the apparatus 800 may be or include at least part of a BS (e.g., BS 102 in FIG. 1).

Referring to FIG. 8, the apparatus 800 may include at least one transmitter 802, at least one receiver 804, and at least one processor 806. The at least one transmitter 802 is coupled to the at least one processor 806, and the at least one receiver 804 is coupled to the at least one processor 806.

Although in this figure, elements such as the transmitter 802, the receiver 804, and the processor 806 are illustrated in the singular, the plural is contemplated unless a limitation to the singular is explicitly stated. In some embodiments of the present application, the transmitter 802 and the receiver 804 may be combined to one device, such as a transceiver. In some embodiments of the present application, the apparatus 800 may further include an input device, a memory, and/or other components. The transmitter 802, the receiver 804, and the processor 806 may be configured to perform any of the methods described herein (e.g., the method described with respect to any of FIGS. 6 and 7).

According to some embodiments of the present application, the apparatus 800 may be a Tx UE, and the transmitter 802, the receiver 804, and the processor 806 may be configured to perform operations of any method performed by a Tx UE as described with respect to FIG. 6. For example, the transmitter 802 may be configured to transmit, within an S-SSB period, information related to S-SSB transmission. The processor 806 may be configured to determine whether or not to utilize one or more class-2 S-SSB occasions within the S-SSB period for S-SSB transmission based at least in part on the information related to S-SSB transmission.

According to some embodiments of the present application, the apparatus 800 may be a BS, and the transmitter 802, the receiver 804, and the processor 806 may be configured to perform operations of any method performed by a BS as described with respect to FIG. 7. For example, the receiver 804 may be configured to receive, within an S-SSB period, information related to S-SSB transmission from a user equipment (UE). The processor 806 may be configured to determine whether or not one or more class-2 S-SSB occasions within the S-SSB period are utilized by the UE for S-SSB transmission based at least in part on the information related to S-SSB transmission.

According to some embodiments of the present application, the apparatus 800 may be a BS, and the transmitter 802, the receiver 804, and the processor 806 may be configured to perform operations of any method performed by a BS as described in the present application. For example, the processor 806 may be configured to: in the case that the receiver 804 receives no request for class-2 S-SSB occasion(s) within an S-SSB period for S-SSB transmission up to a time point within the S-SSB period, determine that all remaining class-2 S-SSB occasion(s) within the S-SSB period can be allocated for SL transmission.

In some embodiments of the present application, the apparatus 800 may further include at least one non-transitory computer-readable medium. In some embodiments of the present disclosure, the non-transitory computer-readable medium may have stored thereon computer-executable instructions to cause the processor 806 to implement any of the methods as described above. For example, the computer-executable instructions, when executed, may cause the processor 806 to interact with the transmitter 802 and/or the receiver 804, so as to perform operations of the method, e.g., as described with respect to any of FIGS. 6 and 7.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for resource allocation in unlicensed spectra including a processor and a memory. Computer programmable instructions for implementing a method for resource allocation in unlicensed spectra are stored in the memory, and the processor is configured to perform the computer programmable instructions to implement the method for resource allocation in unlicensed spectra. The method for resource allocation in unlicensed spectra may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for resource allocation in unlicensed spectra according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

What is claimed is:

1-15. (canceled)

16. A user equipment (UE) for wireless communication, comprising:
at least one memory; and
at least one processor coupled with the at least one memory and operable to cause the UE to:
transmit, within a sidelink synchronization signal block (S-SSB) period, information related to S-SSB transmission; and
determine whether to utilize one or more class-2 S-SSB occasions within the S-SSB period for S-SSB transmission based at least in part on the information related to S-SSB transmission.

17. The UE of claim 16, wherein the information related to S-SSB transmission comprises a request indicating at least one of:
requesting one or more class-2 S-SSB occasions within the S-SSB period for S-SSB transmission;
requesting a first number of one or more class-2 S-SSB occasions within the S-SSB period for S-SSB transmission; or
requesting a set of one or more class-2 S-SSB occasions within the S-SSB period for S-SSB transmission.

18. The UE of claim 17, wherein the at least one processor is operable to cause the UE to:
receive a response indicating one or more allocated class-2 S-SSB occasions to the UE for S-SSB transmission; and
determine to utilize the one or more allocated class-2 S-SSB occasions within the S-SSB period for S-SSB transmission.

19. The UE of claim 18, wherein the response indicates at least one of:
whether the UE can utilize all class-2 S-SSB occasion(s) within the S-SSB period located after a resource on which the response is carried for S-SSB transmission;
whether the UE is able to utilize one or more class-2 S-SSB occasions requested by the UE for S-SSB transmission;
a second number of one or more class-2 S-SSB occasions within the S-SSB period allocated to the UE for S-SSB transmission; or
a set of one or more class-2 S-SSB occasions within the S-SSB period allocated to the UE for S-SSB transmission.

20. The UE of claim 17, wherein the at least one processor is operable to cause the UE to one or more of:
when the request indicates requesting one or more class-2 S-SSB occasions for S-SSB transmission, determine to utilize all class-2 S-SSB occasions within the S-SSB period located after an offset relative to a resource on which the request is carried for S-SSB transmission;
when the request indicates requesting the first number of one or more class-2 S-SSB occasions, determine to utilize the first number of one or more class-2 S-SSB occasions within the S-SSB period for S-SSB transmission, wherein a first one of the first number of one or more class-2 S-SSB occasions is located after an offset relative to the resource on which the request is carried; or
when the request indicates requesting the set of one or more class-2 S-SSB occasions, determine to utilize the set of one or more class-2 S-SSB occasions for S-SSB transmission.

21. The UE of claim 16, wherein the information related to S-SSB transmission comprises a first indicator related to a failure of one or more transmissions on at least one class-1 S-SSB occasion within the S-SSB period, and wherein the at least one processor is operable to cause the UE to:
obtain a linkage which defines a mapping relationship between one or more class-1 S-SSB occasions and one or more class-2 S-SSB occasions within the S-SSB period; and
determine to utilize a set of one or more class-2 S-SSB occasions corresponding to the at least one class-1 S-SSB occasion based on the mapping relationship.

22. The UE of claim 21, wherein the first indicator indicates at least one of:
a failure of one or more transmissions on the at least one class-1 S-SSB occasion within the S-SSB period; or
an index of a class-1 S-SSB occasion within the S-SSB period on which a failure of one or more transmissions occurs.

23. The UE of claim 16, wherein the information related to S-SSB transmission comprises a second indicator indicating a release of one or more class-2 S-SSB occasions.

24. The UE of claim 23, wherein the second indicator is transmitted in response to at least one of:
the UE has successfully performed one or more S-SSB transmissions on one or more class-1 S-SSB occasions within the S-SSB period;
the UE has successfully performed one or more S-SSB transmissions on one or more first N1 S-SSB occasions within the S-SSB period, wherein 0<N1≤N_{MAX}, and N_{MAX} is a total number of S-SSB occasions included in the S-SSB period;
the UE determines to not transmit S-SSB;
the UE detects one or more successful S-SSB transmissions performed by one or more other UEs on one or more class-1 S-SSB occasions within the S-SSB period; or
the UE detects one or more successful S-SSB transmissions performed by one or more other UEs on one or more first N2 S-SSB occasions within the S-SSB period, wherein 0<N2≤N_{MAX}.

25. The UE of claim 23, wherein the second indicator indicates at least one of:
a release of one or more class-2 S-SSB occasions that have not been utilized by the UE within the S-SSB period;
a release of a third number of one or more class-2 S-SSB occasions within the S-SSB period; or
a release of a set of one or more class-2 S-SSB occasions within the S-SSB period.

26. A base station (BS) for wireless communication, comprising:
at least one memory; and
at least one processor coupled with the at least one memory and operable to cause the BS to:
receive, within a sidelink synchronization signal block (S-SSB) period, information related to S-SSB transmission from a user equipment (UE); and
determine whether one or more class-2 S-SSB occasions within the S-SSB period are utilized by the UE for S-SSB transmission based at least in part on the information related to S-SSB transmission.

27. The BS of claim 26, wherein the information related to S-SSB transmission comprises a request indicating at least one of:
requesting one or more class-2 S-SSB occasions within the S-SSB period for S-SSB transmission;
requesting a first number of one or more class-2 S-SSB occasions within the S-SSB period for S-SSB transmission; or
requesting a set of one or more class-2 S-SSB occasions within the S-SSB period for S-SSB transmission.

28. The BS of claim 27, wherein the at least one processor is operable to cause the BS to transmit a response indicating one or more allocated class-2 S-SSB occasions to the UE for S-SSB transmission.

29. The BS of claim 26, wherein the information related to S-SSB transmission comprises a first indicator related to a failure of one or more transmissions on at least one class-1 S-SSB occasion within the S-SSB period, and wherein the at least one processor is operable to cause the BS to:
determine, based on a linkage defining a mapping relationship between one or more class-1 S-SSB occasions and one or more class-2 S-SSB occasions within the S-SSB period, that a set of one or more class-2 S-SSB occasions corresponding to the at least one class-1 S-SSB occasion is utilized by the UE for S-SSB transmission; or
wherein the information related to S-SSB transmission comprises a second indicator indicating a release of one or more class-2 S-SSB occasions.

30. A base station (BS) for wireless communication, comprising:
at least one memory; and
at least one processor coupled with the at least one memory and operable to cause the BS to:
when the BS receives no request for one or more class-2 sidelink synchronization signal block (S-SSB) occasions within an S-SSB period for S-SSB transmission up to a time point within the S-SSB period, determine that one or more remaining class-2 S-SSB occasions within the S-SSB period are allocatable for sidelink transmission.

31. A method performed by a user equipment (UE), the method comprising:
transmitting, within a sidelink synchronization signal block (S-SSB) period, information related to S-SSB transmission; and
determining whether to utilize one or more class-2 S-SSB occasions within the S-SSB period for S-SSB transmission based at least in part on the information related to S-SSB transmission.

32. The method of claim 31, wherein the information related to S-SSB transmission comprises a request indicating at least one of:
requesting one or more class-2 S-SSB occasions within the S-SSB period for S-SSB transmission;
requesting a first number of one or more class-2 S-SSB occasions within the S-SSB period for S-SSB transmission; or
requesting a set of one or more class-2 S-SSB occasions within the S-SSB period for S-SSB transmission.

33. The method of claim 32, further comprising:
receive a response indicating one or more allocated class-2 S-SSB occasions to the UE for S-SSB transmission; and
determine to utilize the one or more allocated class-2 S-SSB occasions within the S-SSB period for S-SSB transmission.

34. The method of claim 33, wherein the response indicates at least one of:
whether the UE can utilize all class-2 S-SSB occasion(s) within the S-SSB period located after a resource on which the response is carried for S-SSB transmission;
whether the UE is able to utilize one or more class-2 S-SSB occasions requested by the UE for S-SSB transmission;
a second number of one or more class-2 S-SSB occasions within the S-SSB period allocated to the UE for S-SSB transmission; or
a set of one or more class-2 S-SSB occasions within the S-SSB period allocated to the UE for S-SSB transmission.

35. The method of claim 32, further comprising one or more of:
when the request indicates requesting one or more class-2 S-SSB occasions for S-SSB transmission, determining to utilize all class-2 S-SSB occasions within the S-SSB period located after an offset relative to a resource on which the request is carried for S-SSB transmission;
when the request indicates requesting the first number of one or more class-2 S-SSB occasions, determining to utilize the first number of one or more class-2 S-SSB occasions within the S-SSB period for S-SSB transmission, wherein a first one of the first number of one or more class-2 S-SSB occasions is located after an offset relative to the resource on which the request is carried; or
when the request indicates requesting the set of one or more class-2 S-SSB occasions, determining to utilize the set of one or more class-2 S-SSB occasions for S-SSB transmission.
